(19) United States
(12) Patent Application Publication
(10) Pub. No.: US 2010/0059639 A1
(43) Pub. Date: Mar. 11, 2010

(54) ARCHERY BOW STAND

(76) Inventor: Dale Truna, Grayling, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 12/555,484

(22) Filed: Sep. 8, 2009

Related U.S. Application Data
(60) Provisional application No. 61/096,104, filed on Sep. 11, 2008.

(51) Int. Cl. F16M 11/00; F16M 13/00

(52) U.S. Cl. 248/125.1; 248/176.3

(57) ABSTRACT

An archery bow stand is provided with an upright guide extending from a base. An upright support cooperates with the upright guide for selective adjustment of an upright position, with a support member sized to receive an archery bow to pivot relative thereto. A horizontal guide extends from the base. A horizontal support having a rest portion, cooperates with the horizontal guide for selective adjustment of a horizontal position. A method for securing a bow to the bow stand is provided by adjusting a vertical position of the support member relative to the upright guide. A horizontal position of the rest portion is adjusted to contact the intermediate portion of the bow thereby limiting the bow from pivoting due to an offset center of gravity, without removing any components from the bow or attaching any fasteners to the bow.

### CROSS-REFERENCE TO RELATED APPLICATIONS

This application claims the benefit of U.S. provisional application Ser. No. 61/096,104 filed Sep. 11, 2008, the disclosure of which is incorporated by reference herein.

### BACKGROUND

1. Technical Field

Embodiments of the invention relate to a stand for supporting an archery bow.

2. Background Art

In the sport of archery, a user utilizes a bow to shoot an arrow at a target. A bow typically includes an intermediate member called a riser with a handle that is connected to opposing limbs, whereby the limbs are connected by a bow string. With respect to function, potential energy is created by the tension in a bow string and limbs as the bow string is pulled away from the riser. When the bow string is released, the potential energy converts to kinetic energy and is applied to an arrow to project it forward at a target.

Archery bows, particularly compound archery bows, include a plurality of adjustable features to allow the user to match the characteristics of the bow to the physical characteristics of the user. Some examples of the adjustable features of a compound bow include: sighting mechanisms, anti-vibration devices, bow string tension and draw length.

There are a variety of bow stands currently available in the market. One example of such prior art, is a stand whereby the user must remove the stabilizer bar from the riser of a compound bow and attach the stand to the stabilizer attachment on the riser to retain the bow. Repeated removal of the stabilizer arm to mount the bow is inconvenient and prevents the user from maintaining a desired adjustment of the stabilizer bar. Also this stand is not applicable for bows that do not use stabilizer bars, such as longbows and recurves.

Another prior art bow stand is one that includes a plurality of clamps to restrain portions of the riser or limbs. These stands typically require the bow to be laid flat on its side, and the clamps are located relatively close together. Since a bow is typically a large flexible object, there can be significant vibration in the bow when making adjustments using such a stand.

### SUMMARY

In at least one embodiment an archery bow stand is provided with a base for resting upon an underlying support surface and an upright guide extending from the base. An upright support cooperates with the upright guide for selective adjustment of an upright position relative to the upright guide, with a support member sized to receive an archery bow to pivot relative thereto. A horizontal guide extends from the base. A horizontal support cooperates with the horizontal guide for selective adjustment of a horizontal position relative to the horizontal guide. A user can seat a limb of the archery bow upon the support member and adjust the upright and horizontal supports so that an intermediate member of the archery bow rests against a rest portion of the horizontal support, thereby limiting the archery bow from pivoting relative to the support member.

In another embodiment a method for securing a bow to a bow stand is provided by adjusting a vertical position of a support member attached to an upright support relative to the upright guide of a bow stand. An upper limb of a bow is rested upon the support member such that an intermediate position of the bow is oriented in a first direction, and the bow is free to pivot relative to the support member. A horizontal position of a first rest portion is adjusted to contact the intermediate portion of the bow thereby limiting the bow from pivoting relative to the support member due to an offset center of gravity, without removing any components from the bow or attaching any fasteners to the bow.

### BRIEF DESCRIPTION OF THE DRAWINGS

FIG. 1 is a side perspective view of an archery bow stand according to an embodiment of the present invention, illustrated supporting an archery bow;

FIG. 2 is another side perspective view of the archery bow stand of FIG. 1, illustrated without an archery bow;

FIG. 3 is an enlarged perspective view of locking mechanisms of the archery bow stand of FIG. 1; and

FIG. 4 is another side perspective view of the archery bow stand of FIG. 1, illustrated supporting the archery bow of FIG. 1 in another position.

### DETAILED DESCRIPTION OF EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

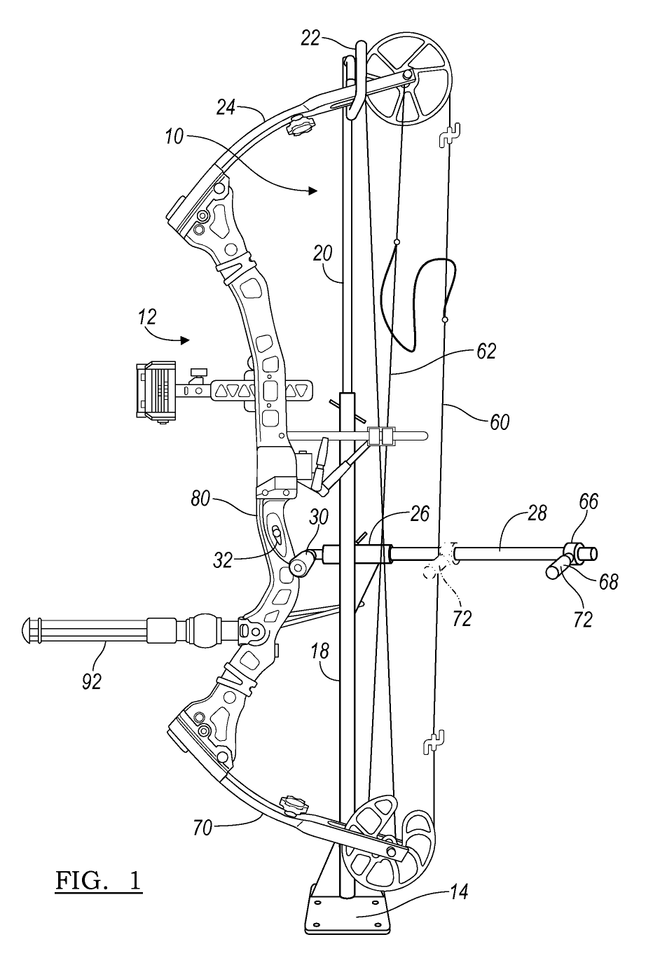

With reference now to FIG. 1, an archery bow stand is illustrated in accordance with an embodiment of the present invention and is referenced by numeral 10. The stand 10 is adjustable to support various archery bows, such as a compound bow 12.

The bow stand 10 allows the user to quickly and easily secure the bow 12 in an upright position so that the user can adjust the features of the bow 12. The stand 10 also allows the user to easily remove the bow 12. Since the compound bow 12 has some features that are more readily accessible on one side than the other, the stand 10 allows the user to reverse the bow 12 about the stand 10.

A typical compound bow 12 includes an intermediate member called a riser 80 with a handle 32 that is connected to opposing upper 24 and lower 70 limbs, whereby the limbs are connected by a bow string 60 and tension cables 62.

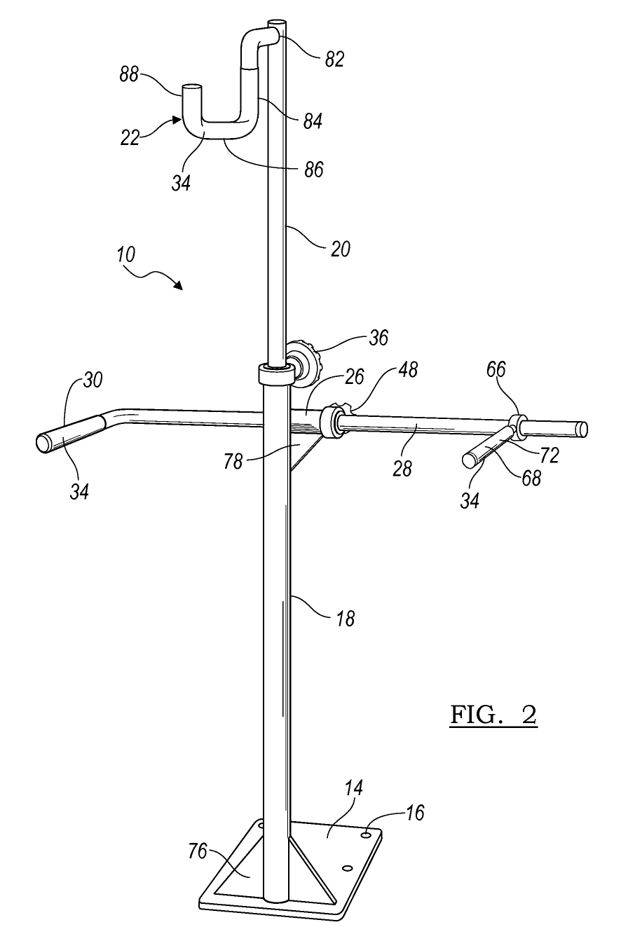

Referring to FIG. 2, the archery bow stand 10 includes a base 14 for supporting the stand on an underlying support surface. The base 14 is flat, and designed to have a surface area that is large enough so that the stand does not require mounting for stability. However an array of clearance holes 16 can be included in the base 14, to allow the user to mount the stand 10 to a bench or table using fasteners, if needed.

An upright guide 18 is mounted to the base 14, and cooperates with an upright support 20 for selective adjustment of an upright position. The guide 18 and the support 20 are of different cross sectional dimensions so that one can envelop the other. In this embodiment, the upright guide 18 is a hollow tube whose inner diameter is slightly larger than the outer diameter of the upright support 20. The upright support 20 includes a hook 22 at the upper end of the support 20. The hook 22 comprises a series of four segments extending from the upright support 20, whereby each segment is bent to extend perpendicularly from the preceding segment. A first segment 82 is welded at a perpendicular orientation to an upper portion of the upright support 20. A second segment 84 extends downward and is perpendicular from the first segment 82. A third segment 86 extends horizontally from the perpendicular second segment 84. A fourth segment 88 extends upwards and is perpendicular from the third segment 86. The hook 22 is sized to receive the upper limb 24 of the bow 12, whereby the limb 24 rests on the third segment 86, and is aligned by the fourth and second segments 88, 84. The support 20 slides within the guide 18 to position the hook 22 at a vertical position. The components of the stand 10 are made of suitable materials such as cold rolled steel. The upright guide 18 is welded to the base 14. For additional support, one or more gussets 76 are welded between the guide 18 and base 14.

A horizontal guide 26 is mounted, for example, welded to an intermediate portion of the upright guide 18. Guide gusset 78 connects the upright guide 18 to the horizontal guide 26 for additional support. A horizontal support 28 cooperates with the horizontal guide 26 for selective adjustment of a horizontal position. In this embodiment, the horizontal guide 26 is a hollow tube whose inner diameter is slightly larger than the outer diameter of the cylindrical horizontal support 28. The horizontal support 28 includes a first rest portion 30 that is bent perpendicular from the support 28. A user can seat an intermediate portion of the bow 12 against the first rest 30, while an upper limb 24 of the compound bow 12 rests upon the hook 22. In most bows, the center of gravity of the compound bow 12 is directed towards the riser 80 (FIG. 1). If the bow 12 were supported, only by the hook 22 of the bow stand 10, then the bow 12 would pivot about the hook 22. The first rest portion 30 prevents the compound bow 12 from pivoting about the hook 22 in a first direction. As seen in FIG. 1, the inner portion of the riser 80 is resting against the first rest support 30, to prevent the bow 12 from pivoting about the hook 22.

To provide further constraint of the bow 12 on the stand 10, the horizontal support 28 also includes a second rest portion 72. The second rest portion 72 can be adjusted to contact an additional intermediate portion of the bow 12. In this embodiment the second rest portion 72 comprises a cylindrical shaft 68 extending from and welded to a rest collar 66, whereby the axes of the shaft 68 and collar 66 are perpendicular. The rest collar 66 has a inner diameter designed to be slightly larger than the outer diameter of the horizontal support 28 to allow the second rest portion 72 to be adjusted along support 28. A set screw (not shown) is included in the collar 66 to allow the user to tighten the screw against the horizontal support 28 to temporarily retain an adjusted position of the second rest 72.

The archery bow stand 10 may also include contact material 34 on portions of the hook 22, and rest portions 30 and 72, that make contact with the bow 12. This contact material 34 is selected from a wide variety of thermosets and thermoplastics known in the art with low abrasion properties, to prevent the stand 10 from scratching contact surfaces on the bow 12. In at least one embodiment the contact material 34 is a rubber that is applied in liquid form and solidifies over time. The outer surfaces of the guides 18 and 26 and base 14 are painted to prevent corrosion.

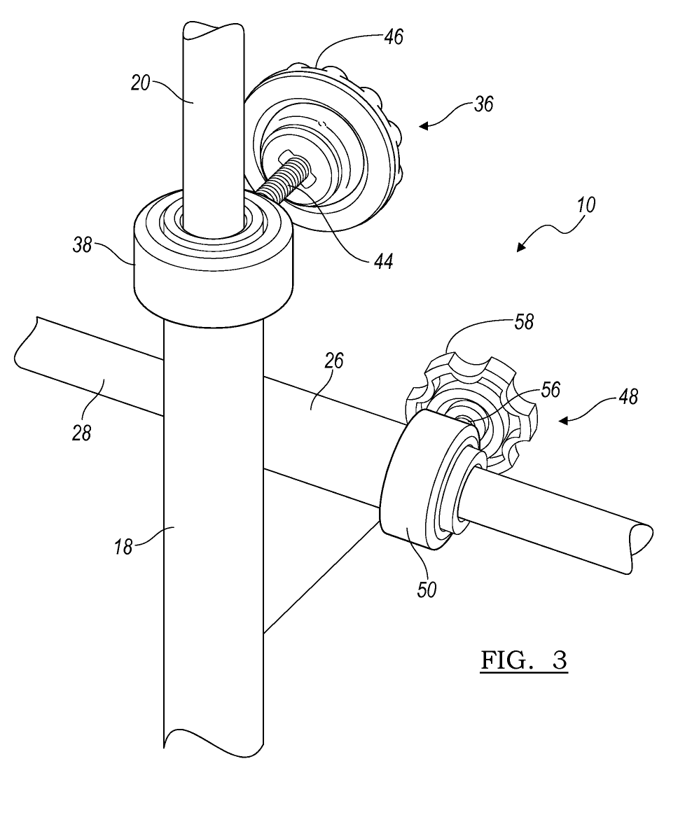

Referring to the FIG. 3, a first locking mechanism 36 allows the user to maintain a selected position of the upright support 20 relative to the upright guide 18. The first locking mechanism 36 includes a first threaded fastener 44 that extends from a first handle 46 and mates with first lock collar 38. Lock collar 38 slides over upright guide 18, and the collar 38 is held in position by tightening a set screw (not shown). Lock collar 38 includes a threaded aperture (not shown) for accepting the threaded fastener 44. The threaded aperture of the collar 38 is aligned with a corresponding aperture (not shown) of the upright guide 18. The threaded fastener 44 cooperates with the threaded aperture of the collar 38 and the aperture of the guide 18 to contact the upright support 20 and maintain an adjusted position of the support 20.

A second locking mechanism 48 allows the user to maintain a selected position of the horizontal support 28 relative to the horizontal guide 26. The second locking mechanism 48 includes a second threaded fastener 56, that extends from a second handle 58 and mates with a second lock collar 50. Lock collar 50 slides over the horizontal guide 26, and the collar 50 is held in position by tightening a set screw (not shown). Lock collar 50 includes a threaded aperture (not shown) for accepting threaded fastener 56. The threaded aperture of collar 50 is aligned with a corresponding aperture (not shown) of the horizontal guide 26. Fastener 56 is inserted into the threaded aperture of the collar 50, and by rotating the handle 58, the fastener 56 translates through the aperture of the guide 26 to contact the horizontal support 28 to maintain an adjusted position of the support 28.

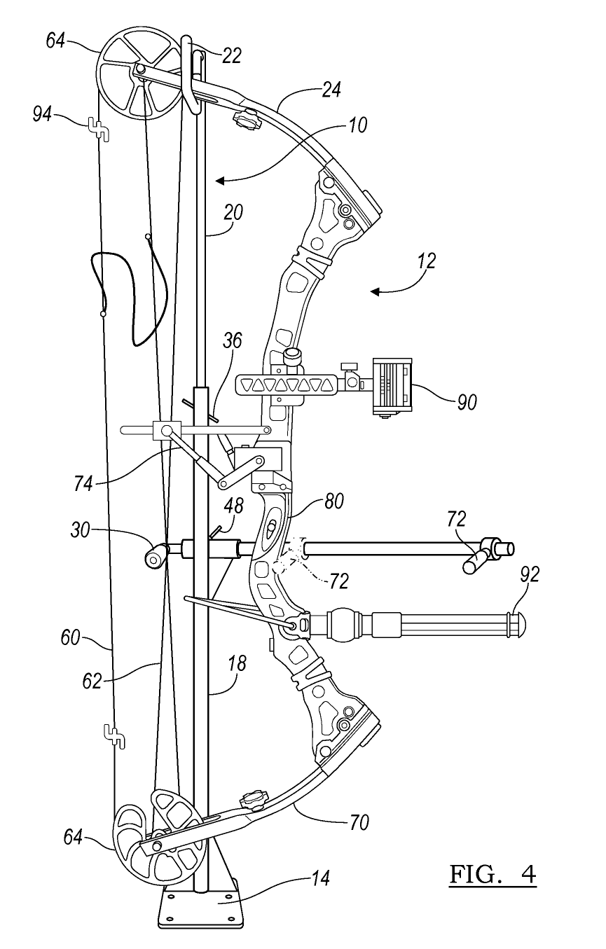

Locking mechanisms 36 and 48 may be implemented in a variety of different ways, as known in the art. As described above for FIGS. 2 and 3, the locking mechanisms may utilize collars 38 and 50 that are attached to the guide tubes 18 and 26. Alternately locking mechanisms may be implemented without collars, whereby the guide apertures are threaded to mate with the fasteners 44 and 56 as shown in FIGS. 1 and 4.

Common threaded fasteners that are designed to be operated by hand, without additional tools, include a variety of styles of handles. FIGS. 1 and 4 illustrate “T” shaped handles, whereas FIGS. 2 and 3 illustrate “knob” handles.

By comparing FIGS. 1 and 4 one can see the versatility of the archery bow stand 10. In FIG. 1, the bow 12 is orientated so that a first side is facing toward the user, with the upper limb 24 resting in the hook 22 and the inner portion of the riser 80 seated against the first rest portion 30 of the horizontal support 28. The second rest portion 72 can be adjusted to contact the bow string 60 for further constraint. FIG. 4 shows the compound bow 12 reversed about the hook 22, with the cables 62 seated against the first rest portion 30, and the outer portion of the riser 80 contacting the second rest portion 72, whereby the user can access a second side and corresponding components of the compound bow 12.

With reference to FIG. 4, the compound bow 12 includes a wide variety of components that require regular maintenance and adjustment including: cables 62 and cams 64 for adjusting string tension and draw length, sighting mechanisms 90, anti-vibration equipment 94 and a stabilizer bar 92.

Often during adjustment an individual will need to make multiple changes to fine tune a certain mechanism. Therefore it is advantageous for the archery bow stand to be designed such that one can quickly and easily mount the bow to the stand and also remove it. It is also common for an archery enthusiasts to own multiple archery bows of different shapes and styles. Therefore an archery bow stand that is easily adjustable to accommodate a variety of bows is ideal. The archery bow stand 10 according to one embodiment of the invention, utilizes a hook 22 and rest portions 30 and 72 to constrain the bow while allowing the user to quickly and easily mount and remove the bow. These constraints, in combination with the flexibility of the adjustment features of the bow stand 10, allow the user to use one archery bow stand 10 to accommodate a wide variety of bows.

The archery bow stand 10 presented herein addresses the deficiencies of the prior art by allowing a user to quickly and easily mount and remove the bow 12 from the stand 10 in an upright position, while also allowing the user to access both sides of the bow 12. Additionally, the bow stand 10 accommodates longbows and recurves, in addition to compound bows 12.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed:

1. An archery bow stand comprising:
a base for resting upon an underlying support surface;
an upright guide extending from the base;
an upright support cooperating with the upright guide for selective adjustment of an upright position relative to the upright guide, with a support member sized to receive an archery bow to pivot relative thereto;
a horizontal guide extending from the base; and
a horizontal support cooperating with the horizontal guide for selective adjustment of a horizontal position relative to the horizontal guide, with a rest portion so that a user can seat a limb of the archery bow upon the support member and adjust the upright and horizontal supports so that an intermediate member of the archery bow rests against the rest portion of the horizontal support thereby limiting the archery bow from pivoting relative to the support member.

2. The archery bow stand of claim 1, wherein the support member receives a portion of the bow laterally offset from a center of gravity of the bow, the rest portion provides a reaction force to counteract a moment created by a weight of the bow and limits the bow from pivoting about the support member.

3. The archery bow stand of claim 1, wherein the bow stand is configured to receive and secure the bow without removing any components from the bow.

4. The archery bow stand of claim 1, wherein the bow stand is configured to receive and secure the bow without engaging any fasteners into the bow.

5. The archery bow stand of claim 1, wherein the support member further comprises a hook.

6. The archery bow stand of claim 1 further comprising a first locking mechanism for maintaining a selected position of the upright support relative to the upright guide.

7. The archery bow stand of claim 1 further comprising a second locking mechanism for maintaining a selected position of the horizontal support relative to the horizontal guide.

8. The archery bow stand of claim 1, wherein one of the upright guide and the upright support has a cross sectional dimension sized to envelop the other.

9. The archery bow stand of claim 5, wherein the hook further comprises a series of segments, wherein each segment extends perpendicularly from a preceding segment.

10. The archery bow stand of claim 5, wherein the hook further comprises:
a first segment extending perpendicularly from an upper portion of the upright support;
a second segment extending downward from the first segment;
a third segment extending horizontally from the second segment; and
a fourth segment extending upwards from the third segment.

11. The archery bow stand of claim 10, wherein the hook is sized to receive an upper limb of the bow, such that the limb rests on the third segment, and is aligned by the fourth and second segments.

12. The archery bow stand of claim 1, wherein the horizontal guide extends from an intermediate portion of the upright guide.

13. The archery bow stand of claim 1, wherein the horizontal guide is a hollow tube having an inner diameter that is slightly larger than an outer diameter of the horizontal support so that the horizontal support translates within the horizontal guide for selective adjustment of a horizontal position.

14. The archery bow stand of claim 1 further comprising a second rest portion that is selectively adjustable along the length of the horizontal support to contact an additional intermediate portion of the bow.

15. The archery bow stand of claim 14, wherein the second rest portion further comprises:
a rest collar having a inner diameter designed to be slightly larger than the outer diameter of the horizontal support, the rest collar having a set screw for selectively engaging the horizontal support; and
a cylindrical shaft extending perpendicularly from the rest collar.

16. The first locking mechanism of claim 6 further comprising:
a first handle for manual adjustment by a user; and
a first fastener extending from the first handle;
wherein the upright guide includes an aperture for receiving the first fastener as the fastener projects through the upright guide for contacting the upright support.

17. The second locking mechanism of claim 7 further comprising:
a second handle for manual adjustment by a user; and
a second fastener extending from the second handle;
wherein the horizontal guide includes an aperture for receiving the second fastener as the fastener projects through the horizontal guide for contacting the horizontal support.

18. A method for securing a bow to a bow stand, the method comprising:
adjusting a vertical position of a support member attached to an upright support relative to the upright guide of a bow stand;
resting an upper limb of a bow upon the support member such that an intermediate position of the bow is oriented in a first direction, and the bow is free to pivot relative to the support member; and
adjusting a horizontal position of a first rest portion to contact the intermediate portion of the bow thereby limiting the bow from pivoting relative to the support member due to an offset center of gravity, without removing any components from the bow or attaching any fasteners to the bow.

19. The method of claim 18, further comprising:
adjusting a second rest portion to contact another intermediate portion of the bow, thereby preventing the bow from pivoting relative to the support member.

20. The method of claim 19, further comprising:
adjusting the second rest portion away from the intermediate portion of the bow;
removing the bow from the bow stand;
resting an upper limb of the bow upon the support member such that the intermediate position of the bow is oriented in a second direction; and
adjusting the second rest portion to contact the intermediate portion of the bow.
